(19) United States
(12) Patent Application Publication
(10) Pub. No.: US 2017/0270550 A1
(43) Pub. Date: Sep. 21, 2017

(54) COMPREHENSIVE APPARATUS FOR RECRUITMENT AND EMPLOYMENT SERVICES FOR MULTIPLE HIRING MANAGERS AND HIRING ENTITIES

(71) Applicant: Bridget Cooper, Novato, CA (US)

(72) Inventor: Bridget Cooper, Novato, CA (US)

(21) Appl. No.: 15/072,725

(22) Filed: Mar. 17, 2016

(51) Int. Cl. G06Q 30/02; G06Q 10/10

(52) U.S. Cl. CPC G06Q 30/0214; G06Q 10/1053

(57) ABSTRACT

Web and mobile based databases, functions, systems and interfaces facilitate recruiting from a point of job order, through the selection process, interview process, to hire and payroll points within a single system that also facilitates the payment of commissions to recruiters or partner entities. A series of graphical user interfaces include interfaces for a registration dashboard, a recruiting dashboard, partner recruiter dashboard, customer dashboard, search engine results interface, commission dashboard, and other interfaces, dashboards and displays useful in facilitating employment recruiting. Video interfaces and video displays assist in the review of job applicants.

### BACKGROUND OF THE INVENTION

(1) Field of the Invention

The invention generally relates to recruitment systems. More particularly, the invention relates to systems and methods for the creation of comprehensive management of recruitment and employment related services encompassing the entire life cycle of the recruitment process.

(2) Description of the Related Art

U.S. Pat. No. 9,152,943 by Joao discloses a system that detects occurrences of job seeking searches. Various search and report systems are disclosed.

U.S. Pat. No. 7,505,919 by Richardson discloses means and methods of incentivizing employers and employees to use employment placement services.

U.S. Pat. No. 8,719,179 discloses several graphical user interfaces used in the recruitment process, but fails to provide a compressive system for multiple parties that encompasses the entire recruitment process. Thus, there is ample room in the art for the presently disclosed embodiments.

### BRIEF SUMMARY OF THE INVENTION

The present invention overcomes shortfalls in the related art by presenting an unobvious and unique combination, configuration and use of databases, memory systems, processors, computer systems, methods and graphical user interfaces to provide a complete ecosystem allowing job seekers, employers, recruiters, employment vendors and other parties to partake in the complete recruitment and employment lifecycle.

Dashboards—Graphical User Interfaces

The known related art fails to disclose, suggest or teach the use of the disclosed dashboards or user interfaces that enable a multitude of different types of participants to engage and profit from the recruitment and employment process. Disclosed systems are comprehensive and create a one point of access for all participants during all phases of recruitment and employment. Disclosed embodiments may include the following dashboards or user interfaces:

1. An administrative dashboard which may be operated by owners of a disclosed system. The related interfaces or dashboards accept input to populate databases and enable computer implemented functions to create job postings, assign jobs to recruiters, assign jobs to account managers, approve or disapprove posting from clients, generate and submit invoices to clients for all types of executed employment such as full time or contract work, display and analyze commissions or compensation earned or purportedly earned by each recruiter, account manager or system partners.

2. A candidate dashboard enabling a job seeker to register in the system and create a profile and to contemporaneously or subsequently augment their profile with availability data, compensation rates, qualifications and skills, resumes and candidate videos. A candidate dashboard or interface may artfully enable a candidate to apply for jobs and to interact with participating recruiters within the disclosed web applications, mobile applications or other means of communication.

3. A recruiter dashboard enabling a recruiter to post jobs, initiate an auto search of system databases using job descriptions and other search criteria, send messages via SMS and other means to selected candidates, create candidate profiles, submit candidates along with notes to hiring managers, manually search system databases, and review commissions earned for each employee or contractor hired.

4. An account manager dashboard enabling an account manager to perform all actions of those of a recruiter as listed above and as further described herein.

5. A company dashboard enabling hiring companies or other employers to register and create a company profile, post jobs, review submitted candidates, review and approve timesheets and invoices.

6. A partner dashboard enabling system partners, system affiliates or outside recruiters to view jobs, submit candidates to a job posting, submit timesheets and review commissions earned for each client employee or contractor hired.

Disclosed embodiments overcome shortfalls in the art by use of disclosed mobile applications or programs used in smartphones or personal electronic devices that allow job seekers or job candidates to register to the system, create a profile, upload a resume and video, receive job notifications, share job openings and other information via social media applications. The disclosed mobile applications overcome shortfalls in the art by use of artful user interfaces and by providing means of transmission of candidate data to recruiters and other apocopate recipients.

Disclosed embodiments include the use of databases, analytics, functions and financial programs wherein candidate resumes and other data is stored in both structured and unstructured database systems that enable:

1. Auto searching of resumes based upon or triggered upon receipt of a new job posting or job requirement data submitted from a hiring manager or other hiring entity.

2. Searches using user defined search terms wherein indexed candidate skills and other search variables are reviewed.

Disclosed embodiments overcome shortfalls in the art by the seamless integration of a billing system that tracks work hours of system employed employees and contractors through time sheets authorized by a hiring manager or company to calculate commissions for the relevant recruiter or account sales manager.

Disclosed embodiments may include machine implemented functions to derive and display system data points.

Disclosed embodiments are well suited for sale or license to in house recruiting organizations that may use their own SMS sourcing, candidate tracking, billing tracking and commission tracking system. Such embodiments may be referred to as “Recruiting as a Service” and may include various dashboards integrated with a purchaser's system.

Disclosed embodiments overcome shortfalls in the art by providing a turnkey and fully integrated and contained system wherein all recruiter and post-employment tracking may stay within the system and wherein candidate interviews may be scheduled, candidate videos may be viewed, payroll of hired candidates may be implemented, time sheet entries may be tracked and approved and used for commission calculations to be paid to recruiter, account managers and system partners.

Additional Dashboards or Additional Dashboard Features

Disclosed embodiments overcome shortfalls in the art by use of various additional dashboards that are machine implemented and that produce tangible results, such dashboards may be implemented with a mobile device or via a more traditional web interface, such dashboards may include:

1. A registration dashboard having means and methods of allowing a job seeker or candidate to enter an email address/phone number, mailing address and consent for system contact via SMS and other means. Means of resume and video upload may be provided. Interaction with a registration dashboard may result in a user name and password being issued to the candidate.

2. A recruiting dashboard may include means and methods of accessing both the structured and unstructured databases containing the resumes and videos of job seekers. Resumes may be parsed by job skills wherein job skill searches will reveal appropriate job seekers. A recruiter dashboard may include the production of or mapping to a recruiter dashboard, with a recruiter dashboard that may comprise columns for:

a) system generated unique candidate identification number;
b) name of candidate;
c) email;
d) cell phone;
e) years of experience;
f) attached resume or video;
g) social media profiles
h) skills;
i) technology;
j) text based summary of skills; and
k) other factors or data points.

3. A search engine dashboard may include means and methods of interfacing with tools used for auto texting and emailing. A search engine dashboard may send data to a recruiter or account manager dashboard. A search engine dashboard may auto select and retrieve a plurality of resumes and candidates who are the most closely matched to the job requirements submitted by a recruiter.

A search engine selected candidate may receive a search engine generated message with the message including a link to skill set requirements, years of required experience and other job related data. Such a message is preferably condensed into one line for ease of texting and text viewing. Texted or other messages to a candidate may include billing rate, location, duration of project with information on potential job length extension, feasibility or permission of sharing the job with others, and means of applying for the job. A job may be applied for by clicking a link or other means. Upon applying for a job, the candidate's resume and video may be sent to the potential employer. The resume or video may be conveyed by sending a link or pointer to the system database containing the resume or video.

4. A multiple recruiter dashboard for a search may service multiple recruiters and allow a recruiter to create a system account and then present and enable a recruiter dashboard which may comprise columns for: job ID, job title, number of positions, job description, pointer or indicator to a job description document stored upon a system database, pointer of indicator to a video or audio file of the candidate stored upon a system database, company name, identity of a hiring manager or recruiter, contact information, a drop down menu for selection of candidates to contact, an indication if a potential contact will accept a text message, a client or employer billing rate, a potential candidate's billing rate, a drop down menu regarding resume submission, recruiter commission based upon a client-candidate bill rate difference, a drop down menu of external postings, and notes made by the recruiter.

5. A master recruiter dashboard may present and enable a master recruiter dashboard or interface that may include all or a subset of the functions and columns of the recruiter dashboard for a search and may further include the following columns or functions: identity of assigned recruiter and search function to identify a qualified recruiter and other functions.

6. A commission dashboard may include function calls to the various system databases and accept variable value changes with such variables used to derive commission amounts. Such functions may include a commission calculator. A commission dashboard may draw information for a recruiter and master recruiter dashboard. A commission dashboard may produce and enable a dashboard or interface that includes columns and functions of: job ID, recruiter, client bill rate, candidate bill rate, percentage of commission—others.

### BRIEF DESCRIPTION OF THE DRAWINGS

FIG. 1 is schematic showing a disclosed embodiments

### REFERENCE NUMERALS IN THE DRAWINGS

100 disclosed system in general

200 mobile application

300 recruiter dashboard

400 partner recruiter dashboard

500 employer or customer dashboard

600 database

700 commission calculation dashboard

720 analytics dashboard

740 time sheet dashboard

800 transmission of information to a candidate

820 transmission of information or data by a candidate

840 transmission of information or data by a partner

860 transmission of information or data by the system

These and other aspects of the present invention will become apparent upon reading the following detailed description in conjunction with the associated drawings.

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

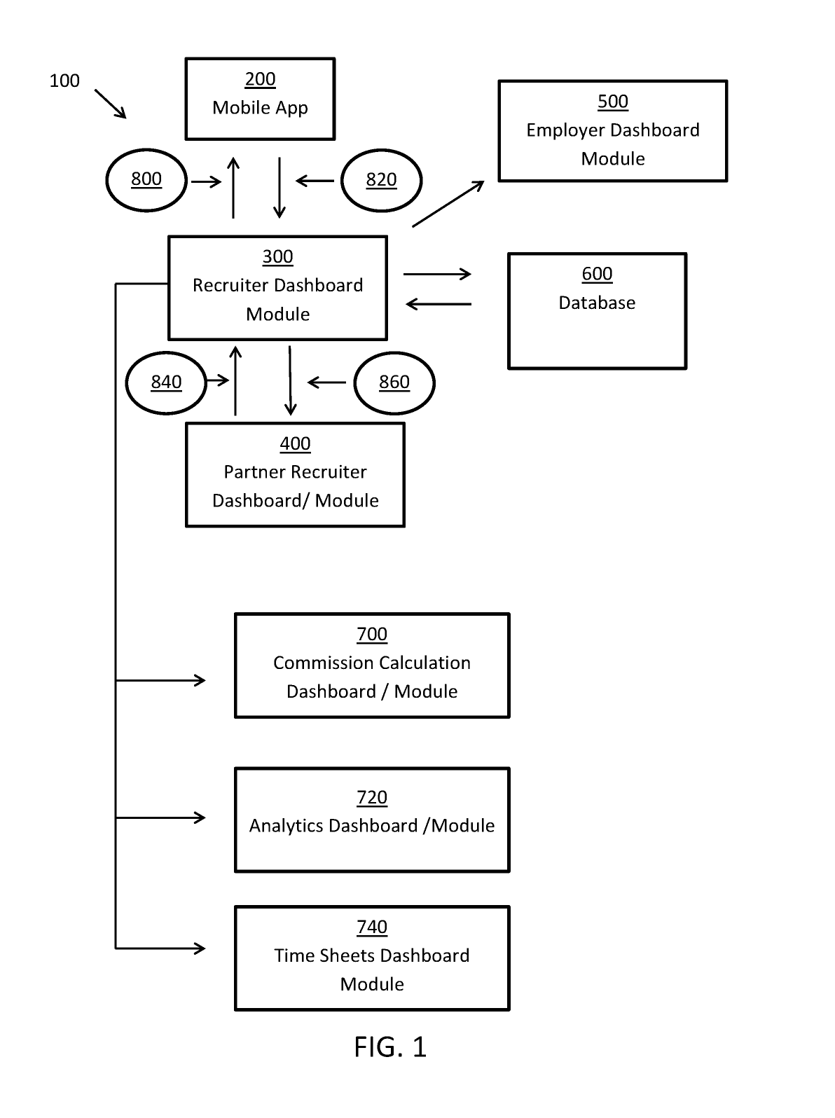

Referring to FIG. 1, a disclosed system 100 may comprise a plurality of dashboards or user interfaces and may include a mobile application 200 sometimes used by job applicants to register into the system and upload video and/or audio files. The mobile application 200 may receive text messages and/or other communications from the system. In one example, a transmission 800 of information from the system to a mobile application may include a text message regarding a job opportunity. In another example a job applicant or candidate transmits 820 a video to the system. The video is preferably made by the candidate and may be used by recruiters or employers to gain a quick assessment of the candidate. A mobile application may be substituted for a traditional web based interface and may communicate with any component of the system.

A candidate may communicate with a recruiter dashboard 300. A recruiter dashboard may transmit and receive data from a database 600, a partner recruiter dashboard 400, a commission calculation dashboard 700, an analytics dashboard 720, a time sheets dashboard 740 as well as any other system component. In one example, a transmission 840 may occur wherein from a partner recruiter to the recruiter dashboard 300. Such a transmission may include the resume and/or video of a job seeker or candidate.

In another example, a transmission 860 of data from the system may be sent to a partner recruiter dashboard 400. Disclosed embodiments contemplate multiple instances of partner recruiter dashboard 400 to accommodate multiple third party recruiters which in turn will increase profits to the system owners.

An analytics dashboard 720 may communicate with the database 600 and calculate and display various data points or data analysis such as system profit and loss, numbers of job registrations open or closed, numbers of candidates engaged with the system, and commission information.

A timesheets dashboard 740 may communicate with the recruiter dashboard 300, the database 600 and other system components and may facilitate the production and entry of time sheets with such time sheets reflecting hours worked. Such time sheets may be presented to a hiring manager or other entity for authorization or approval. Upon approval, such timesheets may be used by the commission calculation dashboard 700 to derive commission amounts.

An employer dashboard 500 may be in communication with the recruiter dashboard 300 and may allow an employer, company or system customer to post job opening, review resumes and other functions as described herein.

Other system components may include non-volatile memory with the non-volatile memory containing machine readable instructions, with the non-volatile memory in communication with a processer and the processor reading the machine readable instructions, the machine readable instructions implementing or reflecting the functions and or dashboards or user interfaces as described herein. The processor may be in further communication with the database 600, with the processor using data from the database 600 to implement the function calls and dashboards and user interfaces described herein.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms.

Disclosed embodiments may include the following items:

Item 1. A system (100) for recruitment and employment services, the system comprising:

a) non-volatile memory with the non-volatile memory containing machine readable instructions, with the non-volatile memory in communication with a processer and the processor reading the machine readable instructions, the machine readable instructions implementing the following dashboard:

i. recruiter;
ii. candidate;
iii. partner recruiter;
iv. employer;
v. commission calculation;
vi. analytics;
vii. timesheets;
viii. payroll

the recruiter dashboard in communication with the processor and the recruiter dashboard in further communication with a candidate mobile application (200), the database, the partner recruiter dashboard, the commission calculation dashboard, the analytics dashboard and the timesheets dashboard;

the mobile application accepting candidate data from candidates, the candidate data entering the recruiter dashboard and furthering the database in the form of sorted and unsorted data;

the employer dashboard accepting job postings with the job postings entering the recruiter dashboard and then the database;

the partner recruiter dashboard accepting candidate data and job postings with the candidate data and job postings stored in the database;

the recruiter dashboard, employer dashboard and partner recruiter dashboard accepting search queries of data stored in the database with search results displayed upon a recruiter dashboard, partner recruiter dashboard and employer dashboard;

the system, using the processor and machine readable instructions generating job match messages to candidates and scheduling interviews.

Item 2. The system of item 1 wherein hired candidates submit data to the time sheets dashboard and wherein the time sheets dashboard generates time sheets for approval by an employer;

Item 3. The system of item 2 wherein approved time sheets are sent to the commission calculation dashboard wherein amounts of commissions are derived.

Item 4. The system of item 3 wherein approved timesheets are submitted to a payroll dashboard which generates instructions for monetary disbursement.

What is claimed is:

1. A system for recruitment and employment services, the system comprising:
a) non-volatile memory with the non-volatile memory containing machine readable instructions, with the non-volatile memory in communication with a processer and the processor reading the machine readable instructions, the machine readable instructions implementing the following dashboards:
i. recruiter;
ii. candidate;
iii. partner recruiter;
iv. employer;
v. commission calculation;
vi. analytics;
vii. timesheets;
viii. payroll
the recruiter dashboard in communication with the processor and the recruiter dashboard in further communication with a candidate mobile application, the database, the partner recruiter dashboard, the commission calculation dashboard, the analytics dashboard and the timesheets dashboard;
the mobile application accepting candidate data from candidates, the candidate data entering the recruiter dashboard and furthering entering the database in the form of sorted and unsorted data;
the employer dashboard accepting job postings with the job postings entering the recruiter dashboard and then the database;
the partner recruiter dashboard accepting candidate data and job postings with the candidate data and job postings stored in the database;
the recruiter dashboard, employer dashboard and partner recruiter accepting search queries of data stored in the database with search results displayed upon a recruiter dashboard, partner recruiter dashboard and employer dashboard; and
the system, using the processor and machine readable instructions generating job match messages to candidates and scheduling interviews.

2. The system of claim 1 wherein hired candidates submit data to the time sheets dashboard and wherein the time sheets dashboard generates time sheets for approval by an employer.

3. The system of claim 2 wherein approved time sheets are sent to the commission calculation dashboard wherein amounts of commissions are derived.

4. The system of claim 3 approved timesheets are submitted to a payroll dashboard which generates instructions for monetary disbursement.
